(19) United States
(12) Patent Application Publication
(10) Pub. No.: US 2013/0285626 A1
(43) Pub. Date: Oct. 31, 2013

(54) DC-DC CONVERTER

(71) Applicants: Yu-Jung Chen, Taipei City (TW); Yen-Ping Wang, Taipei City (TW)

(72) Inventors: Yu-Jung Chen, Taipei City (TW); Yen-Ping Wang, Taipei City (TW)

(73) Assignee: ALITEK TECHNOLOGY CORP., Taipei City (TW)

(21) Appl. No.: 13/458,007

(22) Filed: Apr. 27, 2012

(51) Int. Cl. G05F 1/56; G05F 1/569

(52) U.S. Cl. 323/271

(57) ABSTRACT

A DC-DC converter is provided. The DC-DC converter a power stage includes a first high side driver and a protecting circuit including a second high side driver, wherein the first high side driver and the second high side driver are connected in parallel, and operate in complementary.

### FIELD OF INVENTION

The present invention relates to a DC-DC converter, and more particularly to a DC-DC converter including a short-circuit protecting circuit.

### BACKGROUND

Recently, the power converter has become the most common component applied to a variety of portable electronic products. The power converter such a DC-DC converter serves as a power supply system to convert an input voltage into an output voltage suitable for the appliance. However, if there is a short circuit occurring in the appliance, the output voltage of the power converter will be decreased to about 0V. During the short-circuit period, in order to reduce the restart time of the system, the DC-DC converter outputs a relatively small current to increase the output voltage of the DC-DC converter. In compliance with the specification of the portable electronic devices, it is necessary that the average of the relatively small current is maintained to be less than 6 mA.

When a short circuit occurs, it is necessary for a conventional power converter to provide a clock signal with a very long clock cycle to the power converter, thereby decreasing the average output current of the power converter to meet the requirement of 6mA. Under this condition, a lot of RC circuits are employed to achieve the requirement of the long clock cycle, which may occupy large volume; and even the clock cycle of the clock signal is increased to be a very long clock cycle, the average output current is still as large as 3 A. Thus, some of the conventional DC-DC converters use an extra pin to provide a relatively small current with a long clock cycle; i.e., when a short circuit occurring in the appliance is detected, the conventional DC-DC converter is turned off, and a relatively small current is transmitted from the extra pin to energize the output voltage of the DC-DC converter.

Under this condition, the extra pin is coupled to the output voltage terminal of the conventional power converter, rather than the power stage output terminal of the converter; and the reason is that the power stage output terminal has a high output voltage, which range is in 9V˜40V, but the circuit unit in the conventional DC-DC converter employing the extra pin to output the relatively small current has a power source voltage of 5V and may be unsuitably coupled to the power stage output terminal. Thus, it is necessary to use an extra pin to provide the relatively small current to energize the output voltage of the DC-DC converter when the converter has been turned off. However, in most applications, pins are always insufficient for the IC vendors to achieve the short-circuit protecting purpose.

In order to overcome the drawbacks in the prior art, a DC-DC converter including a protecting circuit is provided in the present invention. The particular design in the present invention not only solves the problems described above, but also is easy to be implemented. Thus, the present invention has the utility for the industry.

### SUMMARY

In accordance with an aspect of the present invention, a DC-DC converter including a protecting circuit is provided. The DC-DC converter of the present invention including a protecting circuit to provide the relatively small current to increase the output voltage of the DC-DC converter without a extra pin.

In accordance with an aspect of the present invention, a DC-DC converter is provided. The DC-DC converter a power stage includes a first high side driver and a protecting circuit including a second high side driver, wherein the first high side driver and the second high side driver are connected in parallel, and operate in complementary.

In accordance with another aspect of the present invention, a DC-DC converter is provided. The DC-DC converter includes a protecting circuit including a relatively small current source; and a first high side driver coupled to the relatively small current source.

In accordance with a further aspect of the present invention, a DC-DC converter is provided. The DC-DC converter includes a power stage including a first output terminal coupled to an input of a load; and a protecting circuit including a second output terminal coupled to the first output terminal and the input.

The above objects and advantages of the present invention will become more readily apparent to those ordinarily skilled in the art after reviewing the following detailed descriptions and accompanying drawings, in which:

### BRIEF DESCRIPTION OF THE DRAWING(S)

FIG. 1 shows a block diagram of a DC-DC converter according to an embodiment of the present invention;

FIG. 2 shows a schematic circuit of a short-circuit detecting circuit that is one embodiment implemented in the present invention;

FIG. 3 shows a schematic circuit of the control circuit 106 implemented in the present invention;

FIG. 4 shows a schematic circuit of the first circuit 108 implemented in the present invention;

FIG. 5A shows a schematic circuit that is the first embodiment of the short-circuit protecting circuit implemented in the present invention;

FIG. 5B shows a schematic circuit that is the second embodiment of the short-circuit protecting circuit implemented in the present invention;

FIG. 6 shows a schematic circuit that is the third embodiment of the short-circuit protecting circuit implemented in the present invention;

FIG. 7 shows a schematic circuit of the second circuit implemented in the present invention;

FIG. 8A shows a block diagram of a DC-DC converter according to an embodiment of the present invention;

FIG. 8B shows a schematic circuit of a DC-DC converter according to an embodiment of the present invention;

FIG. 9 shows a schematic circuit of a DC-DC converter according to another embodiment of the present invention;

FIG. 10A shows a simulation diagram of a second current output by the short-circuit protecting circuit implemented in the present invention, when the input voltage is 40V;

FIG. 10B shows a simulation diagram of a second current output by the short-circuit protecting circuit implemented in the present invention, when the input voltage is 9V; and

FIG. 11 shows a short-circuit protecting circuit output recovery simulation diagram of a DC-DC converter according to one embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

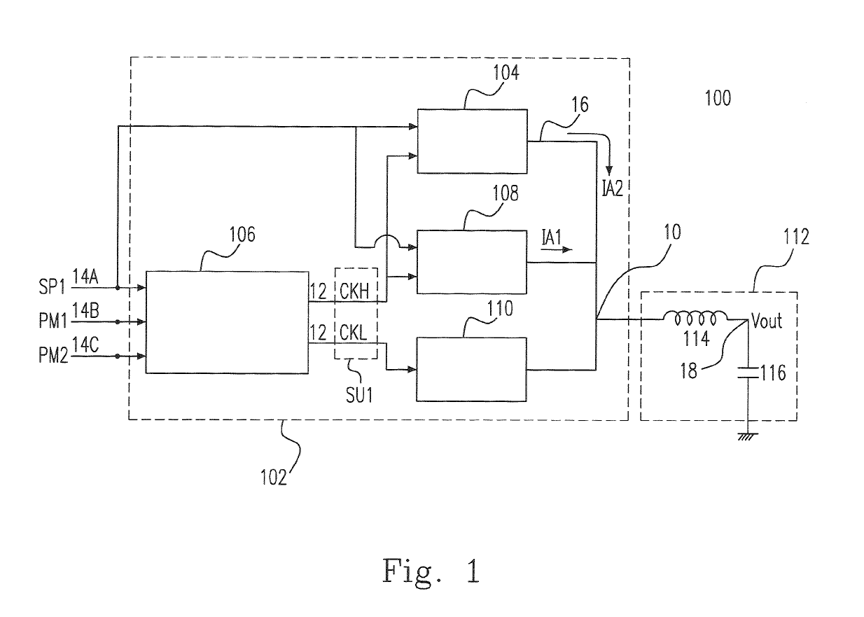

Please refer to FIG. 1, which is a block diagram showing a DC-DC converter 100 according to an embodiment of the present invention. The DC-DC converter 100 includes a first output terminal 18, a power stage 102 and an LC filter 112 and outputs an output voltage Vout at the first output terminal 18, wherein the power stage 102 includes a first circuit 108, a second circuit 110 and a protecting circuit 104. In a preferred embodiment, the power stage 102 includes a second output terminal 10, the control circuit 106, the first circuit 108 and the second circuit 110, and the protecting circuit 104 is coupled to the second output terminal 10. The control circuit 106 includes a third output terminal 12, a first input terminal 14A for receiving a short-circuit protecting (SCP) signal SP1, a second input terminal 14B for receiving a first pulse width modulation (PWM) signal PM1 and a third input terminal 14C for receiving a second PWM signal PM2, and outputs a clock signal SU1 at the third output terminal 12 based on the SCP signal SP1. The first circuit 108 is coupled to the first input terminal 14A and the third output terminal 12, and includes the second output terminal 10. Similarly, the protecting circuit 104 is coupled to the first input terminal 14A and the third output terminal 12, and includes a fourth output terminal 16, wherein the fourth output terminal 16 is coupled to the second output terminal 10, and the first circuit 108 and the short-circuit protecting circuit 104 operates in complementary based on the SCP signal SP1. The second circuit 110 is coupled to the third output terminal 12, and includes the second output terminal 10. The LC filter 112 includes an inductor 114 and a capacitor 116, wherein the inductor 114 is coupled to the second output terminal 10, and the inductor 114 is connected in series with the capacitor 116.

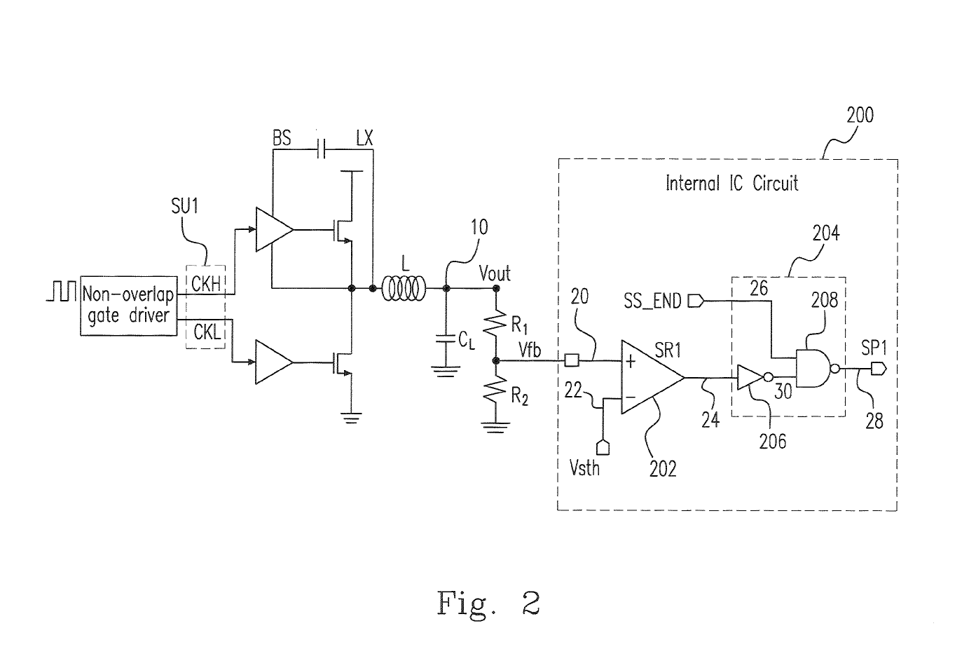

In a preferred embodiment, the DC-DC converter 100 further includes a short-circuit detecting circuit 200 to output the SCP signal SP1 as shown in FIG. 2. FIG. 2 shows a schematic circuit of a short-circuit detecting circuit 200 that is one embodiment implemented in the present invention, and the short-circuit detecting circuit 200 includes a comparator 202 and a second logic circuit 204. The comparator 202 is coupled to a fourth input terminal 20 for receiving a feedback voltage Vfb, a fifth input terminal 22 for receiving a short-circuit protecting threshold voltage Vsth, and compares the feedback voltage Vfb with the short-circuit protecting threshold voltage Vsth to output a comparison result signal SR1 at a fifth output terminal 24. Please refer to FIG. 2, the feedback voltage Vfb is a voltage division of the output voltage Vout, and when there is a short-circuit occurring in a load of the DC-DC converter 100, the feedback voltage Vfb is decreased to about 0V.

The second logic circuit 204 is coupled to the fifth output terminal 24 and a sixth input terminal 26 for receiving a soft start end signal SS_END, and outputs the SCP signal SP1 at a sixth output terminal 28, wherein the soft start end signal SS_END indicates whether the DC-DC converter 100 is at the soft start state. For example, when the feedback voltage Vfb is less than the short-circuit protecting threshold voltage Vsth and the soft start end signal SS_END indicates that the DC-DC converter 100 is at the soft start state, the short-circuit detecting circuit 200 outputs the SCP signal SP1 to indicate that there is not a short circuit occurring. On the other hand, when the feedback voltage Vfb is less than the short-circuit protecting threshold voltage Vsth and the soft start end signal SS_END indicates that the DC-DC converter 100 is not at the soft start state, the short-circuit detecting circuit 200 outputs the SCP signal SP1 to indicate that there is a short circuit occurring.

In another preferred embodiment, the second logic circuit 204 includes an inverter 206 and a NAND gate 208. The inverter 206 is coupled to the fifth output terminal 24 and outputs an inverted comparison result signal at a seventh output terminal 30. The NAND gate 208 is coupled to the sixth input terminal 26 and the seventh output terminal 30, and outputs the SCP signal SP1 at the sixth output terminal 28.

Referring to FIG. 1, when the SCP signal SP1 indicates there is not a short circuit occurring, the control circuit 106 outputs the clock signal SU1 with a first clock cycle length at the third output terminal 12 based on the SCP signal SP1, wherein the clock signal SU1 includes two pulse signals CKH, CKL, and these two pulse signals CKH and CKL operates in complementary. Under this condition, the first circuit 108 and the second circuit 110 operate in complementary in response to these two respective pulse signals CKH and CKL. During the clock high period of the pulse signal CKH, the first circuit 108 outputs a first current IA1 to charge the capacitor 112 to increase the output voltage Vout.

On the other hand, when the SCP signal SP1 indicates there is a short circuit occurring (which means the feedback voltage Vfb is down to about 0V), the control circuit 106 outputs the clock signal SU1 with a second clock cycle at the third output terminal 12 based on the SCP signal SP1, wherein the clock signal SU1 includes two pulse signals CKH, CKL, and these two pulse signals CKH and CKL operates in complementary. The first circuit 108 stops outputting the first current IA1 in response to the SCP signal SP1, and the short-circuit protecting circuit 104 begins to output a second current IA2 to charge the capacitor 112 in response to the SCP signal SP1. In a preferred embodiment, the second clock cycle length is much longer than the first clock cycle length, and the second current IA2 is relatively smaller than the first current IA1. For example, the second current IA2 is smaller than 1/100 time of the first current IA1. In another preferred embodiment, the second current IA2 is smaller than 1/500 time of the first current IA1.

In order to illustrate the DC-DC converter 100, the following will introduce the control circuit 106, the first circuit 108, the second circuit 110 and the short-circuit protecting circuit 104 in detail, respectively.

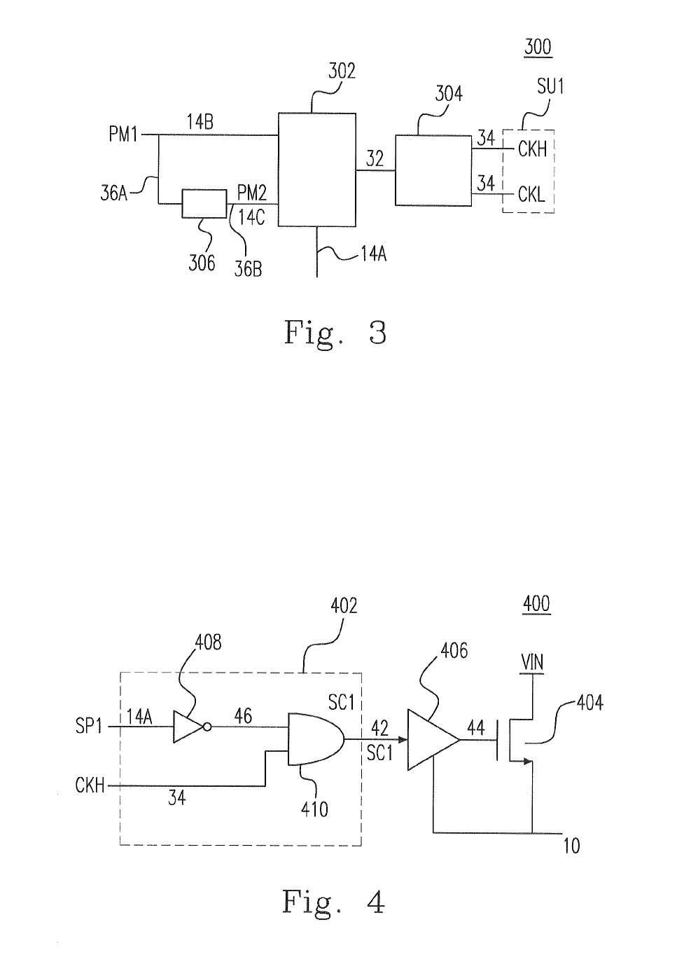

Please refer to FIG. 3, FIG. 3 shows a schematic circuit of the control circuit 106 implemented in the present invention. The control circuit 106 includes a multiplexer (MUX) 302, and a non-overlap gate driver 304, wherein the MUX 302 is coupled to the first input terminal 14A for receiving the SCP signal SP1, the second input terminal 14B for receiving the first PWM signal PM1 and the third input terminal 14C for receiving the second PWM signal PM2, and outputs one of the first PWM signal PM1 and the second PWM signal PM2 at the eighth output terminal 32 based on the SCP signal SP1. The non-overlap gate driver 304 is coupled the eighth output terminal 32, and outputs the clock signal SU1 at a ninth output terminal 34.

In a preferred embodiment, when there is not a short circuit occurring at the output voltage Vout, the MUX outputs the first PWM signal PM1 at the eighth output terminal 32, and the non-overlap gate driver 304 receives the first PWM signal PM1 to output the clock signal SU1 with a first clock cycle length at the ninth output terminal 34. Conversely, when there is a short circuit occurring at the output voltage Vout, the MUX outputs the second PWM signal PM2 at the eighth output terminal 32, and the non-overlap gate driver 304 receives the second PWM signal PM2 to output the clock signal SU1 with a second clock cycle length at the ninth output terminal 34, wherein the second clock cycle length is much longer than the first clock cycle length.

In another preferred embodiment, the control circuit 106 includes a multiplexer (MUX) 302, a non-overlap gate driver 304 and a clock divider 306, wherein the clock divider 306 has two terminals 36A, 36B, one terminal 36A of the clock divider 306 is coupled to the second input terminal 14B for receiving the first PWM signal PM1, and the clock divider 306 outputs the second PWM signal PM2 at the other terminal 36B thereof. The MUX 302 is coupled to the first input terminal 14A for receiving the SCP signal SP1, the second input terminal 14B for receiving the first PWM signal PM1 and the third input terminal 14C for receiving the second PWM signal PM2, and outputs one of the first PWM signal PM1 and the second PWM signal PM2 at the eighth output terminal 32 based on the SCP signal SP1, wherein the second PWM signal PM2 has a much longer clock cycle than the first PWM signal PM1. The non-overlap gate driver 304 is coupled the eighth output terminal 32, and outputs the clock signal SU1 at a ninth output terminal 34.

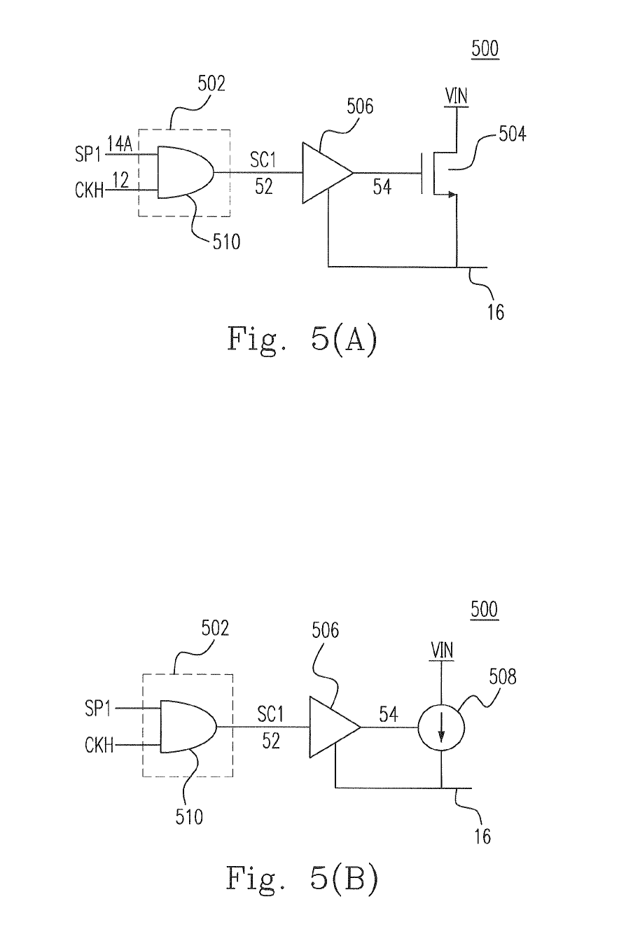

Please refer to FIG. 4, which shows a schematic circuit of the first circuit 108 implemented in the present invention. The first circuit 108 includes a first logic circuit 402, a first MOSFET 404 and a first high side driver 406, and outputs the first current IA1 at the second output terminal 10. The first logic circuit 108 is coupled to the first input terminal 14A and the ninth output terminal 34, and outputs a first control signal SC1 at a tenth output terminal 42. The first high side driver 406 is coupled to the tenth output terminal 42, and includes a eleventh output terminal 44 coupled to the first MOSFET 404. The first logic circuit 402 receives the SCP signal SP1 and the clock signal SU1, and when the SCP signal SP1 indicates there is not a short circuit occurring and the pulse signal CKH is high, the first control signal SC1 output at the tenth output terminal 42 controls the first MOSFET 404 to be turned on through the first high side driver 406 for outputting the first current IA1. On the other hand, when the SCP signal SP1 indicates there is a short circuit occurring or the pulse signal CKH is low, the first control signal SC1 controls the first MOSFET to be turned off through the first high side driver 406 and to stop outputting the first current IA1. In a preferred embodiment, the first MOSFET 404 is a nMOSFET.

In a preferred embodiment, the first logic circuit 402 further includes an inverter 408 and an AND gate 410, as shown in FIG. 4. The inverter 408 is coupled to the first input terminal 14A for receiving the SCP signal SP1, and outputs a inverted SCP signal at a twelfth output terminal 46. The AND gate 410 is coupled to the twelfth output terminal 46 and the ninth output terminal 34, and outputs the first control signal SC1 at the tenth output terminal 42.

Referring to FIGS. 5A and 5B, FIG. 5A shows a schematic circuit that is the first embodiment of the short-circuit protecting circuit 500 implemented in the present invention, and FIG. 5B shows a schematic circuit that is the second embodiment of the short-circuit protecting circuit 500 implemented in the present invention. The protecting circuit 104 includes a third logic circuit 502, a second MOSFET 504 and a second high side driver 506. The third logic circuit 502 is coupled to the first input terminal 14A for receiving the SCP signal SP1 and the third output terminal 12 for receiving the clock signal SU1, and outputs a second control signal SC2 at a thirteenth output terminal 506. The second high side driver 506 is coupled to the thirteenth output terminal 52, and includes a fourteenth output terminal 54 coupled to the second MOSFET 504. When the SCP signal SP1 indicates there is a short circuit occurring and the pulse signal CKH is high, the second control signal SC2 controls the second MOSFET 504 to be turned on through the second high side 506 for outputting the second current IA2 at the fourth output terminal 16. Conversely, when the SCP signal SP1 indicates there is not a short circuit occurring or the pulse signal CKH is low, the second control signal SC2 controls the second MOSFET 504 to be turned off through the second high side driver 506 and to stop outputting the second current. In a preferred embodiment, the second MOSFET 504 is a nMOSFET.

In a preferred embodiment, the protecting circuit 104 includes the third logic circuit 502, a relatively small current source 508 and the second high side driver 506, wherein the relatively small current source 508 is coupled to the fourteenth output terminal 54 and outputs the second current at the fourth output terminal 16, as shown in FIG. 5B. In another preferred embodiment, the third logic circuit 502 includes an AND gate 510 coupled to the first input terminal 14A and the third output terminal 12. In a further preferred embodiment, the first MOSFET 404 has a first channel width to channel length ratio, and the second MOSFET 504 has a second channel width to channel length ratio, wherein the second channel width to channel length ratio is smaller than 1/100 time of the first channel width to channel length ratio.

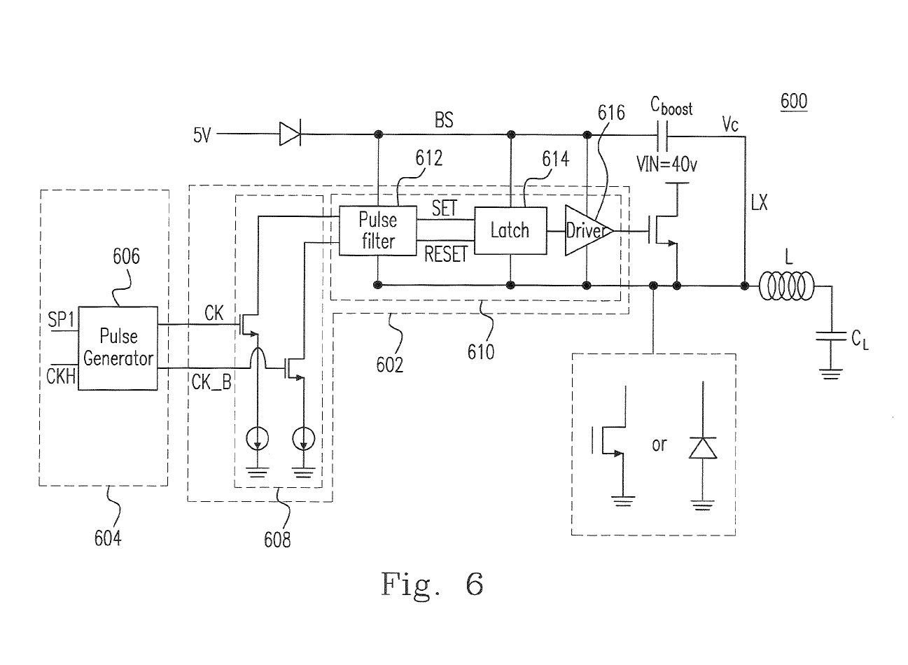

Referring to FIG. 6, FIG. 6 shows a schematic circuit that is the third embodiment of the short-circuit protecting circuit 600 implemented in the present invention. Comparing to FIGS. 5A and 5B, the short-circuit protecting circuit 600 of FIG. 6 depicts a more concrete architecture of the high side driver 602, and the third logic circuit 604 is replaced with a pulse generator 606. The high side driver 602 includes a level shifting circuit 608 and a high side circuit 610, wherein the high side circuit 610 is a circuit with a floating voltage between a node BS and a node LX, and the voltage difference between the node BS and the node LX is 5V. The high side circuit 610 includes a pulse filter 612, a latch 614 and a driver 616. The pulse generator 606 receives the SCP signal SP1 and the pulse signal CKH and generates two pulse signals CK, CK_B to control the level shifting circuit 608 in response to the SCP signal SP1 and the pulse signal CKH, wherein these two pulse signals CK, CK_B are generated in response to the rising edge and falling edge of the pulse signal CKH. These two pulse signals CK, CK_B through the level shifting circuit 608 control the pulse filter 612 to output a set signal SET and a reset signal RESET, wherein the set signal SET and the reset signal RESET to set or reset the latch 610 to output an output driving signal of the floating voltage to drive the driver 616.

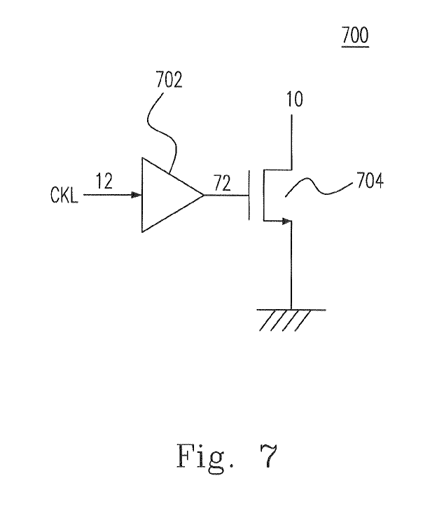

Please refer to FIG. 7, FIG. 7 shows a schematic circuit of the second circuit 700 implemented in the present invention. The second circuit 700 includes a low side driver 702 and a third MOSFET 704 coupled to the second output terminal 10, wherein the low side driver 702 coupled to the third output terminal 12 for receiving the pulse signal CKL, and including a fifteenth output terminal 72 coupled to the third MOSFET 704. In a preferred embodiment, the third MOSFET 704 is a nMOSFET.

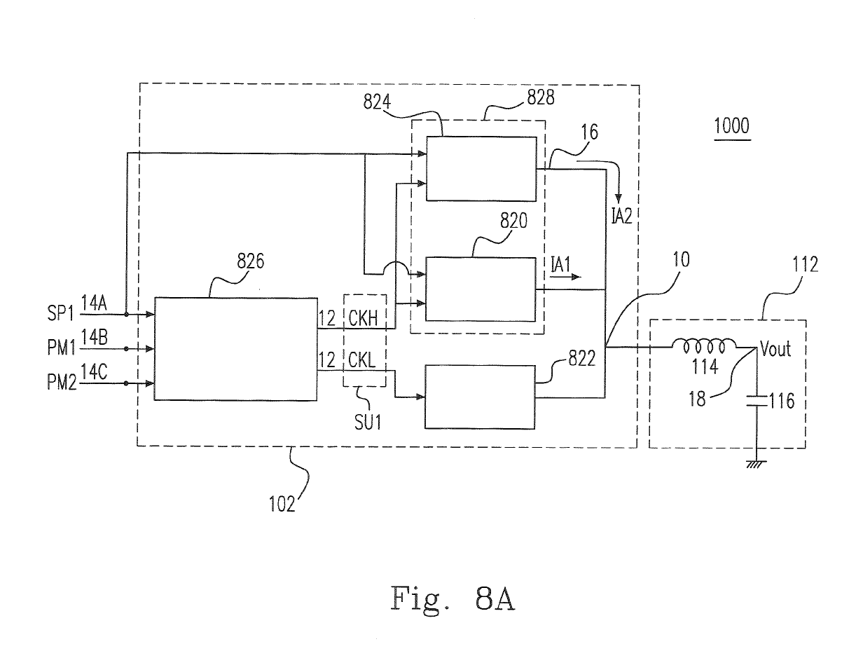

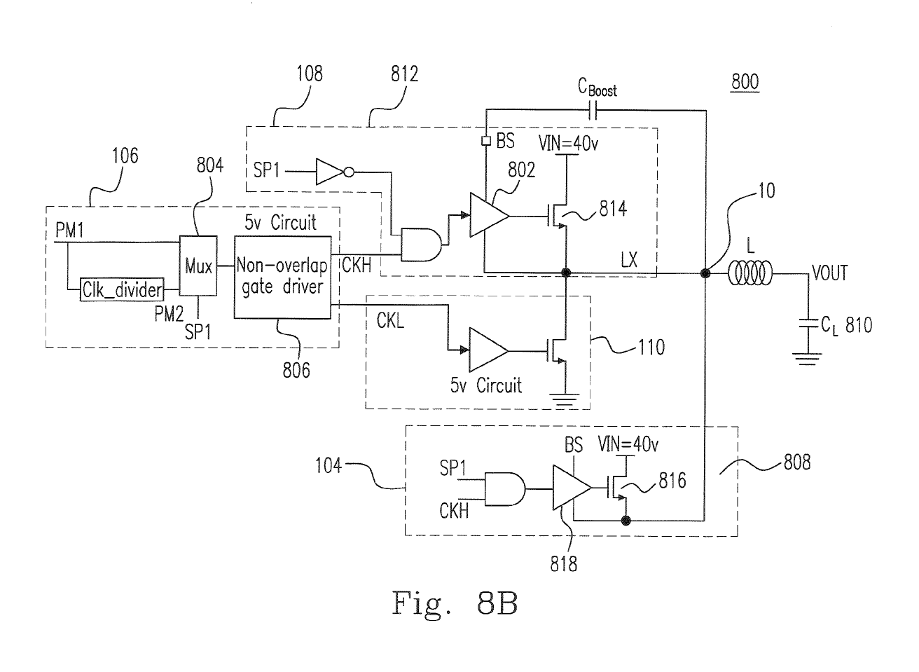

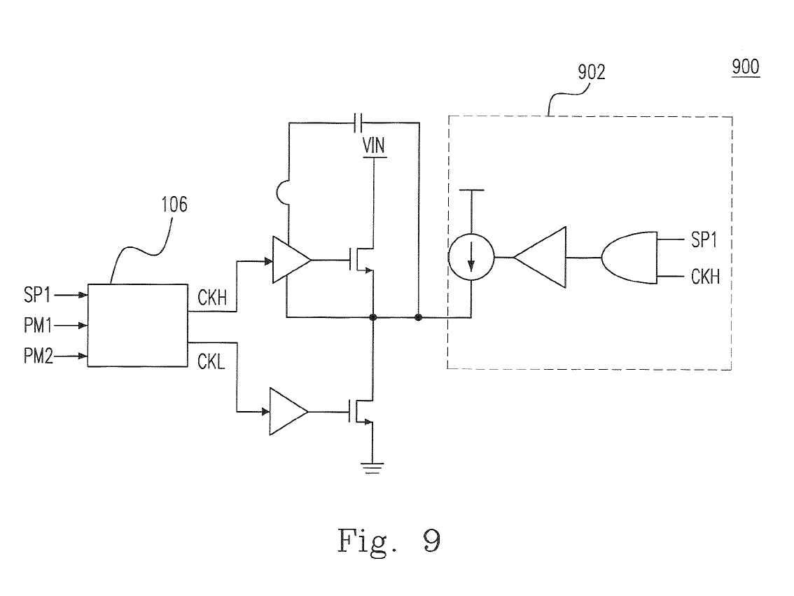

Please refer to FIGS. 1-7. In a preferred embodiment, the first circuit 400 is a first high side subcircuit 820, the protecting circuit 500 is a second high side subcircuit 824, and the second circuit 700 is a low side bridge circuit 822. Please refer to FIG. 8A, which is a block diagram showing a DC-DC converter 1000 according to an embodiment of the present invention. Based on the description mentioned above, the DC-DC converter 1000 is a preferred embodiment of the DC-DC converter 100, includes a control circuit 826, the high side bridge circuit 828 and the low side bridge circuit 822, wherein the high side bridge circuit 828 includes the first high side subcircuit 820 and the second high side subcircuit 824. When there is a not short circuit occurring and the pulse signal CKH output by the control circuit 826 is high, the first high side subcircuit 820 outputs the first current IA1. On the other hand, when there is a short circuit occurring and the pulse signal CKH output by the control circuit 826 is high, the second high side subcircuit 824 outputs the second current IA2, wherein the second current IA2 is relatively smaller than the first current IA1. In a preferred embodiment, the second high side subcircuit 824 includes a current source with small current.

FIG. 8B shows a schematic circuit of a DC-DC converter 800 according to one embodiment of the present invention. The circuit described in FIG. 8B is derived from the circuit shown in FIG. 1. The block 106 is replaced with the control circuit 300 described in FIG. 3, the block of the first circuit 108 is replaced with the above mentioned circuit described in FIG. 4, the block 104 is replaced with the short-circuit protecting circuit 500 described in FIG. 5A, the block of the second circuit 110 is replaced with the above mentioned circuit described in FIG. 7. The DC-DC converter 800 further includes a capacitor CBoost coupled between the first high side driver 802 and the second output terminal 10. In a preferred embodiment, the protecting circuit 104 is included in the power stage 102, and the first high side driver 802 is connected in parallel with the second high side driver 818, wherein the first high side driver 802 and the second high side driver 818 operate in complementary. During the short-circuit period, the MUX 804 outputs the second PWM signal PM2 and the non-overlap gate driver 806 outputs a clock signal SU1 with a second clock cycle in response to the second PWM signal PM2. The short-circuit protecting circuit 808 outputs the second current IA2 in response to the SCP signal SP1 and the clock signal SU1 with the second clock cycle to charge the capacitor 810; at this moment, the first circuit 812 turns off the first MOSFET 814 through the first high side driver 802 in response to the SCP signal SP1 and the clock signal SU1 with the second clock cycle. During the normal operation period, the MUX 804 outputs the first PWM signal PM1 and the non-overlap gate driver 806 outputs a clock signal SU1 with a first clock cycle in response to the first PWM signal PM1, wherein the second clock cycle has a much lower frequency than the first clock cycle. The first circuit 812 outputs the first current IA1 in response to the SCP signal SP1 and the clock signal SU1 with the first clock cycle to charge the capacitor 810; at this moment, the short-circuit protecting circuit 808 turns off the second MOSFET 816 through the second high side driver 818.

FIG. 9 shows a schematic circuit of a DC-DC converter 900 according to another embodiment of the present invention. Comparing to FIG. 8B, the short-circuit protecting circuit 902 of FIG. 9 is replace with the above mentioned circuit described in FIG. 5B.

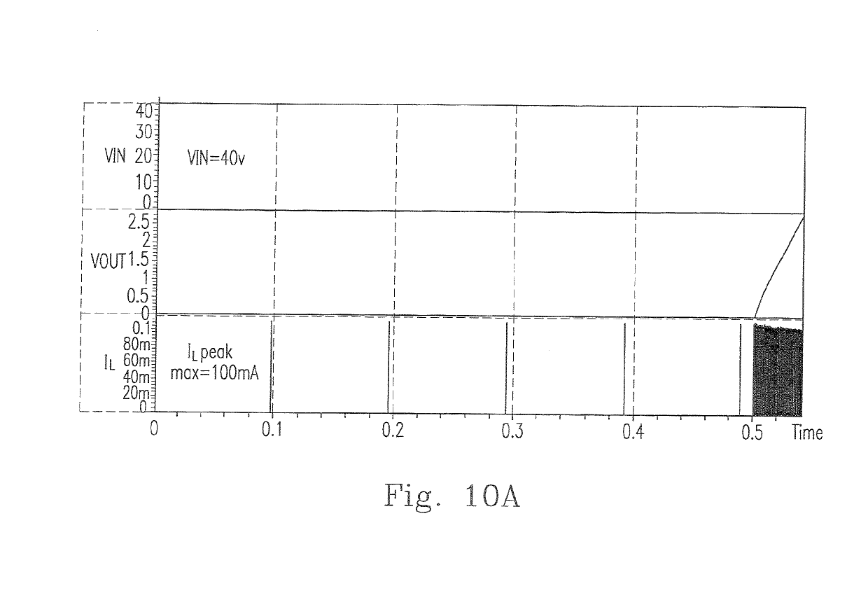

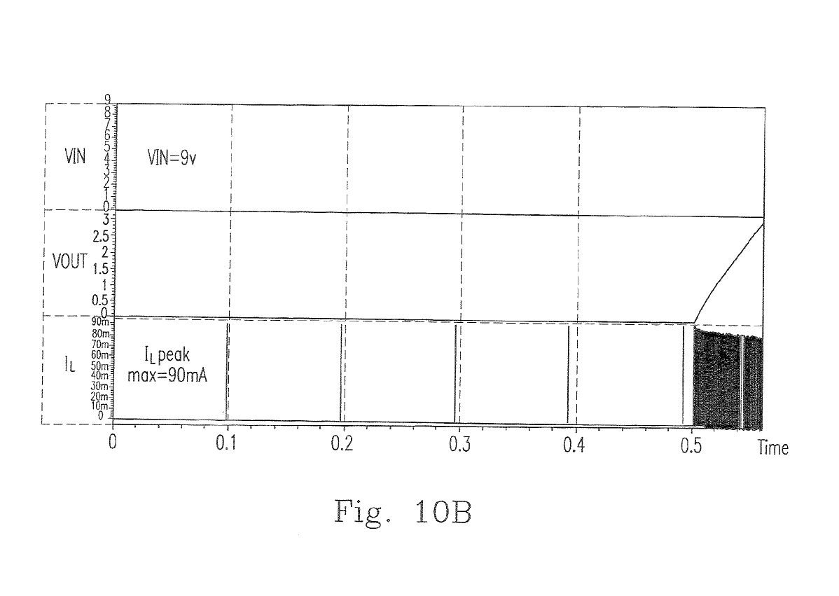

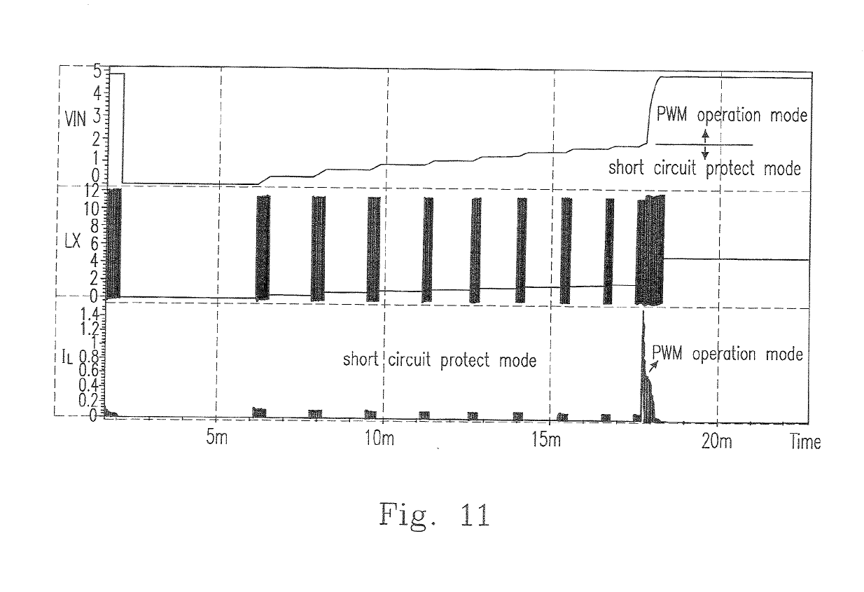

Please refer to FIGS. 10A and 10B, FIG. 10A shows a plurality of waveforms of the current I_{L}(the second current output by the short-circuit protecting circuit 104) flowing through the inductor L, input voltage VIN and the output voltage Vout according to the DC-DC converter 800 implemented in FIG.8 in the present invention, when the input voltage VIN is 40V; and FIG. 10B shows a plurality of waveforms of the current I_{L} (the second current output by the short-circuit protecting circuit 104) flowing through the inductor L, the input voltage VIN and the output voltage Vout according to the DC-DC converter 800 implemented in FIG.8 in the present invention, when the input voltage VIN is 9V. As shown in FIGS. 10A and 10B, it can be inferred that during the short-circuit period, the clock cycle of the current I_{L}(the second current output by the short-circuit protecting circuit 104) flowing through the inductor L is very long; and in spite of the input voltage VIN ranged between 9V and 40V, the current I_{L}(the second current output by the short-circuit protecting circuit 104) flowing through the inductor L is ranged between 90 mA and 100 mA which is very stable. FIG. 11 shows a plurality of waveforms of the output voltage Vout, the voltage LX (the voltage at the second output terminal 10), and the current I_{L} (the second current output by the short-circuit protecting circuit 104) flowing through the inductor L according to the DC-DC converter 800 implemented in FIG.8 in the present invention. It can be seen that under the short-circuit protecting mode of the DC-DC converter 800, the short-circuit protecting circuit 104 continually outputs a relatively small current IL to increase the output voltage Vout until the short circuit is resolved; and then the DC-DC converter 800 is changed into a PWM operation mode (normal operation mode). Because the output voltage Vout is increased during the short-circuit protecting mode, the DC-DC converter 800 can be restarted quickly to begin to work.

### EMBODIMENTS

1. A DC-DC converter, comprising:
a power stage including:
a first high side driver; and
a protecting circuit including a second high side driver,
wherein the first high side driver and the second high side driver are connected in parallel, and operate in complementary.
2. The DC-DC converter of Embodiment 1, wherein the power stage further comprises:
a first circuit including the first high side driver; and
a control circuit including a first output terminal, a first input terminal for receiving a short-circuit protecting (SCP) signal, a second input terminal for receiving a first pulse width modulation (PWM) signal and a third input terminal for receiving a second PWM signal, and outputting a clock signal at the first output terminal based on the SCP signal.
3. The DC-DC converter of any one of Embodiments 1-2, wherein the first circuit further comprises:
a first logic circuit including a second output terminal, a fourth input terminal for receiving the clock signal and a fifth input terminal for receiving a SCP signal, and
outputting a first control signal at the second output terminal;
a third output terminal;
a first MOSFET including the third output terminal; and
the first high side driver including a fourth output terminal coupled to the first MOSFET.
4. The DC-DC converter of any one of Embodiments 1-3, wherein the first logic circuit further comprises:
an inverter coupled to the fifth input terminal, and including a fifth output terminal for outputting an inverted SCP signal; and
an AND gate coupled to the fifth output terminal and the first output terminal, and outputting the first control signal at the second output terminal.
5. The DC-DC converter of any one of Embodiments 1-4, wherein the protecting circuit further comprises:
a second MOSFET including a sixth output terminal;
a second logic circuit including a seventh output terminal, a sixth input terminal for receiving the SCP signal and a seventh input terminal for receiving the clock signal, and outputting a second control signal at the seventh output terminal; and
the second high side driver coupled to the seventh output terminal and including an eighth output terminal coupled to the second MOSFET.
6. The DC-DC converter of any one of Embodiments 1-5, wherein the first MOSFET has a first channel width and the second MOSFET has a second channel width to channel length ratio, and the second channel width is smaller than the first channel width to channel length ratio.
7. The DC-DC converter of any one of Embodiments 1-6, wherein when the SCP signal indicates there is not a short circuit occurring in a output voltage of the converter, the first control signal triggers the first high side driver to drive the first MOSFET to output a first current, and the second control signal turns off the second high side driver.
8. The DC-DC converter of any one of Embodiments 1-7, wherein when the SCP signal indicates there is a short circuit occurring in a output voltage of the converter, the second control signal triggers the second high side driver to drive the second MOSFET to output a second current, and the first control signal turns off the first high side driver.
9. The DC-DC converter of any one of Embodiments 1-8, wherein the second current is smaller than 1/100 time of the first current.
10. The DC-DC converter of any one of Embodiments 1-9, wherein the control circuit further comprises:
a multiplexer (MUX) including a ninth output terminal and coupled to the first input terminal, the second input terminal and the third input terminal; and
a non-overlap gate driver coupled to the ninth output terminal and outputting the clock signal at the first output terminal.11. The DC-DC converter of any one of Embodiments 1-10, wherein the power stage further comprises a clock divider including a first and second terminals, wherein the first divider terminal is coupled to the second input terminal and the second divider terminal is coupled to the third input terminal.
12. A DC-DC converter, comprising:
a protecting circuit including:
a relatively small current source; and
a first high side driver coupled to the relatively small current source.
13. The DC-DC converter of Embodiments 12, wherein the DC-DC converter further comprises a power stage including a first input terminal for receiving a first SCP signal and a first output terminal for outputting a first current.
14. The DC-DC converter of any one of Embodiments 12-13, wherein the protecting circuit further comprises:
a first logic circuit including a second output terminal, a second input terminal for receiving the first SCP signal and a third input terminal for receiving a clock signal; a third output terminal; and
the relatively small current source coupled to the second output terminal and outputting a second current at the third output terminal, wherein the second current is smaller than 1/100 time of the first current.
15. The DC-DC converter of any one of Embodiments 12-14, wherein the DC-DC converter further comprises:
a short-circuit detecting circuit for outputting the first SCP signal, comprising:
a comparator including a fourth output terminal, a fourth input terminal for receiving a feedback voltage, a fifth input terminal for receiving a short-circuit threshold voltage, and outputting a second SCP signal at the fourth output terminal; and
a second logic circuit including a fifth output terminal, a sixth input terminal for receiving a soft start end signal and a seventh input terminal coupled to the fourth output terminal, and outputting the first SCP signal at the fifth output terminal.
16. The DC-DC converter of any one of Embodiments 12-15, wherein the second logic circuit further comprises:
an inverter coupled to the fourth output terminal and including a sixth output terminal for outputting a third SCP signal; and
a NAND gate including the sixth input terminal and coupled to the seventh output terminal and outputting the first SCP signal at the fifth output terminal.
17. A DC-DC converter, comprising:
a power stage including a first output terminal coupled to an input of a load; and
a protecting circuit including a second output terminal coupled to the first output terminal and the input.
18. The DC-DC converter of Embodiments 17, wherein the load further comprises a LC filter.
19. The DC-DC converter of any one of Embodiments 17-18, wherein the power stage further comprises a first circuit outputting a first current at the first output terminal.
20. The DC-DC converter of any one of Embodiments 17-19, wherein when there is a short circuit occurring in a output voltage of the converter, the protecting circuit outputs a relatively small current at the second output terminal, and the first circuit stops outputting the first current.

The DC-DC converter of the present invention includes a protecting circuit to provide a relatively small current to increase the output voltage, during the short-circuit period. The design of the protecting circuit reduces the restart time of the system and does not need an extra pin to provide the relatively small current.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A DC-DC converter, comprising:
a power stage including:
a first high side driver; and
a protecting circuit including a second high side driver,
wherein the first high side driver and the second high side driver are connected in parallel, and operate in complementary.

2. A DC-DC converter as claimed in claim 1, wherein the power stage further comprises:
a first circuit including the first high side driver; and
a control circuit including a first output terminal, a first input terminal for receiving a short-circuit protecting (SCP) signal, a second input terminal for receiving a first pulse width modulation (PWM) signal and a third input terminal for receiving a second PWM signal, and outputting a clock signal at the first output terminal based on the SCP signal.

3. A DC-DC converter as claimed in claim 2, wherein the first circuit further comprises:
a first logic circuit including a second output terminal, a fourth input terminal for receiving the clock signal and a fifth input terminal for receiving a SCP signal, and outputting a first control signal at the second output terminal;
a third output terminal;
a first MOSFET including the third output terminal; and
the first high side driver including a fourth output terminal coupled to the first MOSFET.

4. A DC-DC converter as claimed in claim 3, wherein the first logic circuit further comprises:
an inverter coupled to the fifth input terminal, and including a fifth output terminal for outputting an inverted SCP signal; and
an AND gate coupled to the fifth output terminal and the first output terminal, and outputting the first control signal at the second output terminal.

5. A DC-DC converter as claimed in claim 2, wherein the protecting circuit further comprises:
a second MOSFET including a sixth output terminal;
a second logic circuit including a seventh output terminal, a sixth input terminal for receiving the SCP signal and a seventh input terminal for receiving the clock signal, and outputting a second control signal at the seventh output terminal; and
the second high side driver coupled to the seventh output terminal and including an eighth output terminal coupled to the second MOSFET.

6. A DC-DC converter as claimed in claim 5, wherein the first MOSFET has a first channel width and the second MOSFET has a second channel width to channel length ratio, and the second channel width is smaller than the first channel width to channel length ratio.

7. A DC-DC converter as claimed in claim 5, wherein when the SCP signal indicates there is not a short circuit occurring in a output voltage of the converter, the first control signal triggers the first high side driver to drive the first MOSFET to output a first current, and the second control signal turns off the second high side driver.

8. A DC-DC converter as claimed in claim 5, wherein when the SCP signal indicates there is a short circuit occurring in a output voltage of the converter, the second control signal triggers the second high side driver to drive the second MOSFET to output a second current, and the first control signal turns off the first high side driver.

9. A DC-DC converter as claimed in claim 8, wherein the second current is smaller than 1/100 time of the first current.

10. A DC-DC converter as claimed in claim 2, wherein the control circuit further comprises:
a multiplexer (MUX) including a ninth output terminal and coupled to the first input terminal, the second input terminal and the third input terminal; and
a non-overlap gate driver coupled to the ninth output terminal and outputting the clock signal at the first output terminal.

11. A DC-DC converter as claimed in claim 2, wherein the power stage further comprises a clock divider including a first and second terminals, wherein the first divider terminal is coupled to the second input terminal and the second divider terminal is coupled to the third input terminal.

12. A DC-DC converter, comprising:
a protecting circuit including:
a relatively small current source; and
a first high side driver coupled to the relatively small current source.

13. A DC-DC converter as claimed in claim 12, wherein the DC-DC converter further comprises a power stage including a first input terminal for receiving a first SCP signal and a first output terminal for outputting a first current.

14. A DC-DC converter as claimed in claim 13, wherein the protecting circuit further comprises:
a first logic circuit including a second output terminal, a second input terminal for receiving the first SCP signal and a third input terminal for receiving a clock signal;
a third output terminal; and
the relatively small current source coupled to the second output terminal and outputting a second current at the third output terminal, wherein the second current is smaller than 1/100 time of the first current.

15. A DC-DC converter as claimed in claim 11, wherein the DC-DC converter further comprises:
a short-circuit detecting circuit for outputting the first SCP signal, comprising:
a comparator including a fourth output terminal, a fourth input terminal for receiving a feedback voltage, a fifth input terminal for receiving a short-circuit threshold voltage, and outputting a second SCP signal at the fourth output terminal; and
a second logic circuit including a fifth output terminal, a sixth input terminal for receiving a soft start end signal and a seventh input terminal coupled to the fourth output terminal, and outputting the first SCP signal at the fifth output terminal.

16. A DC-DC converter as claimed in claim 15, wherein the second logic circuit further comprises:
an inverter coupled to the fourth output terminal and including a sixth output terminal for outputting a third SCP signal; and
a NAND gate including the sixth input terminal and coupled to the seventh output terminal and outputting the first SCP signal at the fifth output terminal.

17. A DC-DC converter, comprising:
a power stage including a first output terminal coupled to an input of a load; and
a protecting circuit including a second output terminal coupled to the first output terminal and the input.

18. A DC-DC converter as claimed in claim 17, wherein the load further comprises a LC filter.

19. A DC-DC converter as claimed in claim 17, wherein the power stage further comprises a first circuit outputting a first current at the first output terminal.

20. A DC-DC converter as claimed in claim 19, wherein when there is a short circuit occurring in a output voltage of the converter, the protecting circuit outputs a relatively small current at the second output terminal, and the first circuit stops outputting the first current.
